(19) United States
(12) Patent Application Publication
(10) Pub. No.: US 2008/0133309 A1
(43) Pub. Date: Jun. 5, 2008

(54) System and method for monitoring and controlling a shop floor

(75) Inventor: Louis J. Maggio, Central Islip, NY (US)

Correspondence Address: CASELLA & HESPOS, 274 MADISON AVENUE, NEW YORK, NY, 10016, US

(73) Assignee: Elemco Software Integration Group Ltd., Islandia, NY (US)

(21) Appl. No.: 11/985,886

(22) Filed: Nov. 19, 2007

Related U.S. Application Data
(60) Provisional application No. 60/859,631, filed on Nov. 17, 2006.

(51) Int. Cl. G06F 17/30

(52) U.S. Cl. 705/9; 705/7

(57) ABSTRACT

A system and method for monitoring and controlling a process workflow, e.g., a shop floor, are provided. The system and method of the present disclosure enable, for example, a manufacturing facility to monitor a workflow process to afford better control over the workflow process and avoid duplication of efforts, e.g., entering of the same information into disparate systems. The system and method provide for selecting at least one process unit, at least one activity and at least one material; verifying the selected at least one material is available for production; scheduling use of the selected at least one processing unit and determining an amount of labor needed based on the selected at least one process unit and at least one activity; and providing an indication to commence production upon verification of the availability of the selected at least one material and the needed labor.

This application claims priority to an application entitled “SYSTEM AND METHOD FOR MONITORING AND CONTROLLING A SHOP FLOOR” filed in the United States Patent and Trademark Office on Nov. 17, 2006 and assigned Ser. No. 60/859,631, the contents of which are hereby incorporated by reference.

### BACKGROUND OF THE INVENTION

1. Field of the Invention

The present disclosure relates generally to data processing and workflow control systems, and more particularly, to a system and method for monitoring and controlling a shop floor.

2. Description of the Related Art

Traditionally, production information at shop floors is collected by hand. For example, by dictation and recording with a pen, or by manually inputting data into a computer terminal. It takes a long time to collect the original information, let alone effectively organize and analyze the collected information and finally respond to it. It is imperative for many enterprises to establish a system for instantly monitoring production information and quickly responding to problems identified at the shop floor. Such system can greatly improve efficiency and effectiveness of production.

### SUMMARY OF THE INVENTION

A system and method for monitoring and controlling a process workflow, e.g., a shop floor, are provided. The system and method of the present disclosure enable, for example, a manufacturing facility to monitor a workflow process from a single integrated suite of software running on a server, e.g., an Application Server Provider (ASP), RoR server, etc., to afford better control over the workflow process and avoid duplication of efforts, e.g., entering of the same information into disparate systems. The system and method will receive a workflow order and track and schedule various subprocesses, e.g., ordering and receiving of material, inventory control, labor scheduling, etc., to avoid waste and downtime due to, for example, shortages of material and unavailability of labor and production lines.

According to one aspect of the present disclosure, a system for managing a production order of a shop floor is provided including a quoting module configured for selecting at least one process unit, at least one activity and at least one material for the production order; a shop order module configured for verifying the selected at least one material is available for production; a scheduling module configured for scheduling use of the selected at least one processing unit and determining an amount of labor needed based on the selected at least one process unit and at least one activity; wherein the shop order module is further configured to verify the availability of the amount of labor and provide an indication to commence production upon verification of the availability of the selected at least one material and the needed labor.

In another aspect, the quoting module is further configured: to associate with the at least one process unit one of a number of people per operating hour required to operate, a cost per man hour to operate and hours of operation; to associate with the at least one activity one of a flat fee for activity, man hours per activity and cost per man hour; and to associate with the at least one material one of a quantity per one of the material, price per unit and shrinkage per one.

In a further aspect, an expected materials module is configured to determine if the selected at least one material is in inventory. In another aspect, the expected materials module is further configured to generate an external supplier order if the selected at least one material is not inventory.

In yet another aspect, a receiving and labeling module configured to record the receipt of materials from an external supplier and generate a label to associate the received material to the production order. In another aspect, the receiving and labeling module is further configured to indicate a location for the received material.

In another aspect, the quoting module is further configured for assigning a sequence number to the at least one process unit and at least one activity, wherein the at least one process unit and the at least one activity is processed sequentially according to the assigned sequence number. Furthermore, the quoting module is further configured to assign the selected at least one material to the selected at least one process unit and/or at least one activity.

In another aspect, an RF module is configured for entering material into inventory, wherein the shop order module verifies the selected at least one material based on an amount of the selected at least one material in inventory.

In still another aspect, the quoting module is configured for determining a cost for the production order.

According to another aspect of the present disclosure, a method for managing a production order of a shop floor is provided, the method comprising the steps of providing a web site for generating a production order hosted by at least one server in communication with the network; receiving an indication for selecting at least one process unit, at least one activity and at least one material for the production order by the web site; verifying the selected at least one material is available for production; scheduling use of the selected at least one processing unit and determining an amount of labor needed based on the selected at least one process unit and at least one activity by the web site; verifying the availability of the amount of labor; and providing an indication to commence production upon verification of the availability of the selected at least one material and the needed labor.

According to a further aspect of the present disclosure, an apparatus for managing a production order of a shop floor over a network includes means for providing a web site for generating a production order hosted by at least one server in communication with the network; means for receiving an indication for selecting at least one process unit, at least one activity and at least one material for the production order by the web site; means for verifying the selected at least one material is available for production; means for scheduling use of the selected at least one processing unit and determining an amount of labor needed based on the selected at least one process unit and at least one activity by the web site; means for verifying the availability of the amount of labor; and means for providing an indication to commence production upon verification of the availability of the selected at least one material and the needed labor.

According to yet another aspect of the present disclosure, a system for managing a production order of a shop floor over a network is provided. The system includes at least one first server in communication with the network configured for generating a production order; and at least one first client in communication with the network configured for selecting at least one process unit, at least one activity and at least one material for the production order; wherein the at least one first server further configured for verifying the selected at least one material is available for production, scheduling use of the selected at least one processing unit and determining an amount of labor needed based on the selected at least one process unit and at least one activity, verifying the availability of the amount of labor and providing an indication to the at least one first client to commence production upon verification of the availability of the selected at least one material and the needed labor. The at least one first client is further configured to associate with the at least one process unit one of a number of people per operating hour required to operate, a cost per man hour to operate and hours of operation; the at least one first client is configured to associate with the at least one activity one of a flat fee for activity, man hours per activity and cost per man hour; the at least one first client is configured to associate with the at least one material one of a quantity per one of the material, price per unit and shrinkage per one.

In another aspect, the at least one first server is configured to determine if the selected at least one material is in inventory. The at least one first server is further configured to generate an external supplier order if the selected at least one material is not inventory and transmit the generated external supplier order to at least one second server. Furthermore, the at least one first server is configured to record the receipt of materials from the external supplier and generate a label at the least one client to associate the received material to the production order.

In a further aspect, the at least one first client is further configured for assigning a sequence number to the at least one process unit and at least one activity, wherein the at least one process unit and the at least one activity is processed sequentially according to the assigned sequence number. Additionally, the at least one client is further configured to assign the selected at least one material to the selected at least one process unit and/or at least one activity.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of an exemplary system for monitoring and controlling a shop floor in accordance with an embodiment of the present disclosure;

FIG. 2 is a diagram of an exemplary server for monitoring and controlling a shop floor in accordance with an embodiment of the present disclosure;

FIG. 3 is a flow chart illustrating various modules of the system and method for monitoring and controlling a shop floor in accordance with another embodiment of the present disclosure;

FIG. 4 is a flow chart illustrating an initialization process of the system and method of the present disclosure;

FIG. 5 is a flow chart illustrating a process for defining process units in accordance with the present disclosure;

FIG. 6 is a flow chart illustrating a process for defining a rack location in a facility in accordance with the present disclosure;

FIG. 7 is a flow chart illustrating a process for creating a material list in accordance with the present disclosure;

FIG. 8 illustrates an overall flow of generating a quote for a production order and processing the production order to a finished product in accordance with the present disclosure;

FIG. 9 is a flow chart illustrating a quality control process in accordance with the present disclosure;

FIG. 10A is a screen shot illustrating a process of adding a process unit to a quote, FIG. 10B is a screen shot illustrating a process of adding an activity to a quote and FIG. 10C is a screen shot illustrating a process of adding material to a quote;

FIG. 11 is a screen shot illustrating rack locations of a facility in accordance with the present disclosure;

FIGS. 12A-D are exemplary screen shots of a shop order being processed by the system and method of the present disclosure where FIG. 12A shows details of process units being utilized, FIG. 12B shows status of activities, FIG. 12C shows details of materials for the shop order and FIG. 12D shows any storage restrictions associated to the shop order; and

FIG. 13 is a screen shot illustrating scheduling of the shop order on the production floor in accordance with the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for monitoring and controlling a process workflow, e.g., a shop floor, are provided. The system and method of the present disclosure enable, for example, a manufacturing facility to monitor a workflow process from a single integrated suite of software running on a server, e.g., an Application Server Provider (ASP), to afford better control over the workflow process and avoid duplication of efforts, e.g., entering of the same information into disparate systems. The system and method will receive a workflow order and track and schedule various subprocesses, e.g., ordering and receiving of material, inventory control, labor scheduling, etc., to avoid waste and downtime due to, for example, shortages of material and unavailability of labor and production lines. Advantageously, the system and method of the present disclosure can be utilized in the production of cosmetics and pharmaceuticals and in a food processing facility.

In one embodiment, the system of the present disclosure is implemented as a comprehensive cost-saving Software as a Service (SaaS) solution for tracking and validating material use from the time it is received to the time it is shipped. The system is comprised of a series of functional modules that can be implemented in a variety of ways. The system and method of the present disclosure provides at least the following functionality: job quoting, quality control (QC), material availability, records the arrival of material into the facility and generates the required labels, calculates the jobs that can be run in a facility based on known bill of materials, identifies materials that need to be retested prior to shop floor order's execution, will identify scheduled jobs that are affected by inventory changes, locates material manually or by using RF Scanners, generates cycle count reports and bar coded labels, produces daily production schedules, displays the production lines that are currently scheduled and orders being run on them and tracks labor used on a particular production order.

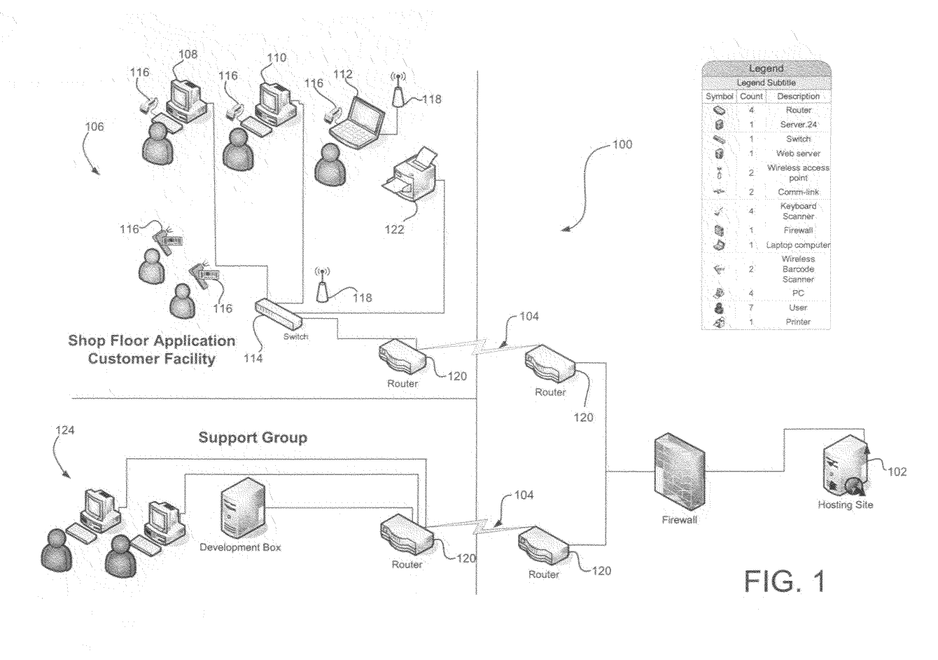

Referring to FIG. 1, a system 100 for monitoring and controlling a shop floor according to an aspect of the present disclosure is illustrated. The system 100 includes at least one server 102 coupled over a network 104 to at least one facility 106, e.g., a manufacturing facility. The at least one server 102 operates as an ASP server or a Rails server (also known as a Ruby on Rails or RoR) for providing the functionality of the shop floor control module, which will be described below, to a plurality of client computers 108, 110, 112 associated with the facility 106. It is to be appreciated that the plurality of client computers may be disposed in a single facility or may be disposed over several locations coupled together by various conventional means, for example, a LAN, WAN, etc. By providing a server/client architecture, any client computer may access the server 102 from any location and all information relating to the workflow process will be centralized in one location facilitating maintenance and upgrading of software. Any client in the system 100 will have access to all the information for a particular facility regardless of the location of the client. It is further to be appreciated that the server may be located in the same facility via an intranet or any where in the world via the Internet.

Each of the plurality of client computers 108, 110, 112 may be located at various locations of a facility, e.g., where a subprocess of the workflow process begins. The plurality of client computers 108, 110, 112 may be coupled within the facility 106 by any conventional means for example by switch 114. The facility 106 will include at least one reader device 116 for entering and tracking material in the workflow process. The reader device 116 may include but is not limited to a barcode reader, an RFID tag reader, etc. The reader devices 116 may be coupled to the client computers by hardwire or by any known wireless connection means, e.g., Bluetooth, WiFi, IrDA, etc. When employing wireless reader devices 116, the facility 106 will include wireless access points 118 for receiving information from the reader devices 116. The facility 106 also includes at least one printing device 122 for printing labels, e.g., barcode labels, reports, work orders, etc.

It is to be appreciated that due to the server/client architecture of the system 100 only the server needs to be upgraded when or if necessary and not each of the clients. Furthermore, a support group 124 may be provided any where in the world to provide technical support and direct access troubleshooting.

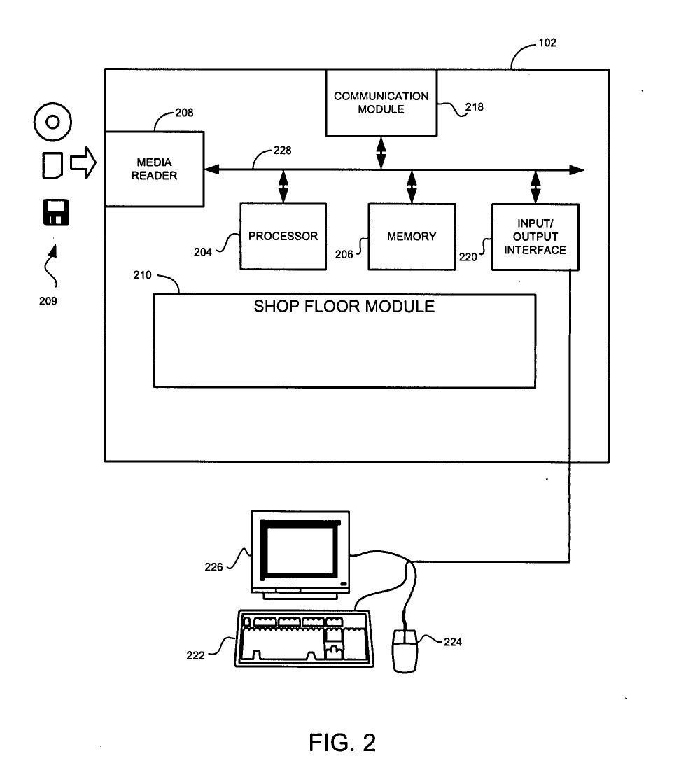

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by a machine, e.g., server 102, comprising any suitable architecture such as a personal computer, a workstation or server, as shown in FIG. 2. Preferably, the server 102 is implemented on a computer platform having hardware such as one or more central processing units (CPU) 204, a random access memory (RAM) 206, a read only memory (ROM) 206 and input/output (I/O) interface(s) 220 such as a keyboard 222, cursor control device 224 (e.g., a mouse or joystick) and display device 226, e.g., a monitor. A system bus 228 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof which is executed via the operating system.

In addition, various other peripheral devices may be connected to the computer platform of the machine by various interfaces and bus structures, such a parallel port, serial port or universal serial bus (USB). One such peripheral device may include a communication module 218, e.g., a modem, satellite relay, wireless connection, etc., for enabling communications from the server 102 to the various client computers 108, 110, 112. A media reader 208 may be included for reading various types of media 209, e.g., uploading application software. Other peripheral devices may include additional storage devices, a printer and a scanner.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The server 102 may operate in a networked environment using logical connections to one or more remote computers, e.g., client computers 108, 110, 112. The remote computer may be a personal computer, a server, a router, a network PC, a peer device or other common network node, and typically includes many or all of the elements described above relative to the machine. It is to be appreciated that the network 104 may be a local area network (LAN), wide area network (WAN), the Internet or any known network that couples a plurality of computers to enable various modes of communication via network messages. The server 102 may communicate to the client computers 108, 110, 112 and network 104 via any known communication link, for example, dial-up, hardwired, cable, DSL, satellite, cellular, PCS, wireless transmission (e.g., 802.11a/b/g, etc.), etc. Furthermore, the devices will communicate using the various known protocols such as Transmission Control Protocol/Internet Protocol (TCP/IP), File Transfer Protocol (FTP), Hypertext Transfer Protocol (HTTP), etc. During a purchasing transaction, the computing devices may employ Hypertext Transfer Protocol Secure (HTTPs), Secure Sockets Layer (SSL) Protocol, Secure Electronic Transaction (SEC) Protocol, etc. The system 100 may employ at least one router 120 to facilitate communications over the network.

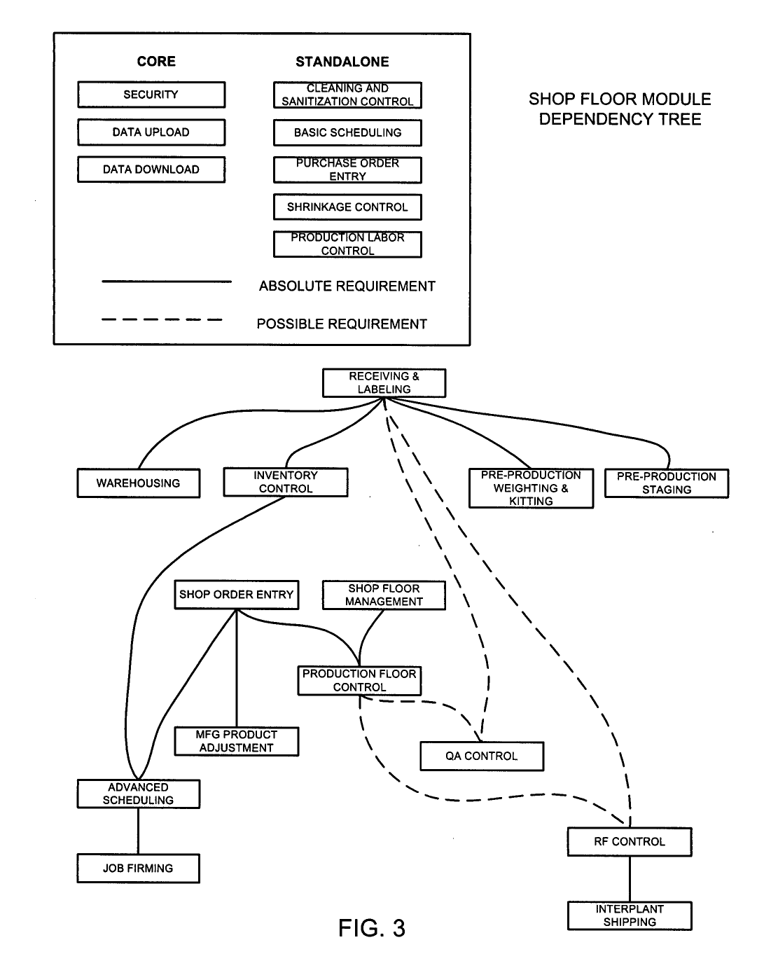

The server 102 will include shop floor module 210 stored in memory for monitoring and controlling a workflow process according to the present disclosure. The shop floor module 210 includes a plurality of modules, some of which are illustrated in FIG. 3, wherein each module will now be described below. In the following description, the following terms will be employed: ESF Suite—the collection of the Elemco Shop Floor (ESF) Modules 210 available to be implemented at a facility 106; ESF-Enabled Facility—a company with one or more production facilities that utilize the ESF suite to enhance their operation; ESF Owner—each ESF-Enabled Facility has a controlling user account for configuring the system and creating other user accounts, this controlling account is known as the ESF Owner; ESF Member—every user at the ESF-Enabled Facility is an ESF Member, ESF Members have access to use the ESF Suite; and BOM is Bill of Materials.

System Security Module (Core Functionality)

Protecting the data of each ESF-Enabled Facility is an integral part of the Elemco Shop Floor Suite or shop floor module 210. A strict Sarbanes-Oxley compliant security module will monitor and control each user's access throughout the ESF Suite.

Data Import Module (Core Functionality)

To simplify data entry and minimize errors, many components of shop floor module 210 utilize this module's functionality for uploading data through special Excel spreadsheets. Example Template Spreadsheets: Open Purchase Orders, Shop Orders, Inventory, Process Instructions, Item Master, Business Rules, Employee Lists, Labor Standards, Operating Standards, Warehouse Bar-coded rack information, BOM data, production offsets.

Data Export Module (Core Functionality)

Production data can be downloaded as Excel spreadsheets and is available in lieu of paper-formatted reports in some modules of the shop floor module. Each shop floor module that allows for data uploads via Excel spreadsheets also allows for data downloads in the same format. Data download for extraction or peace of mind. Example: Starting inventory, reduced by the shop floor or shrinkage module, is available as an ending inventory data download.

Shop Order Entry Module

Shop Orders can either enter the ESF Suite electronically, e.g. from another system through spreadsheets, or manually—this module allows for the manual entry of Shop Orders. UK Terms: Work production order, customer order (assembly companies only), bulk production order.

Quoting Module

Quoting Module allows the Receiving Module to verify incoming materials and generate the required labels. Quoting Module can also be used as an expected receipt for materials arriving from an outside source. (PO=Inbound purchase orders). Details of the Quoting Module will be described below.

Expected Materials Module

Using information from the Data Upload or Quoting Module, this module shows the material availability based on warehouse inventory and receipt of material from suppliers.

Receiving & Labeling Inventory Module

Using information from the Data Upload or Quoting Module, this module records the arrival of materials into the facility and generates the required labels so the material is forwarded to its proper location, e.g., a warehouse or production line. The Receiving Module is required for the Inventory Control and Warehousing Modules. This module will differentiate between inventory that is and is not owned by the ESF-Enabled Facility 106 and will generate supplier orders to acquire needed material. Enhanced By: Quoting Module differentiate between supplier, customer, and personal lot numbers.

Inventory Control Module

Using information from the Data Upload or Receiving & Labeling Modules, this module calculates the jobs that can be run in a facility based on the known Bills of Materials. With the QA Control Module activated, this module can show materials that need to be retested prior to the shop floor order's execution. Aged inventory reports are available from this module. With the Advanced Schedule Module activated, the schedule will distinguish jobs that are affected by inventory changes. Requires: Receiving & Labeling Inventory Module Enhanced By: QA Control, RF Control, Warehousing Modules

Warehousing Module

Using information from the Data Upload or Receiving & Labeling Modules, this module acts as a locator system and allows materials to be located manually or using RF guns or readers 116. This module returns materials to the warehouse and generates cycle count reports and bar coded rack labels. With the Shop Floor Management Module activated, the Warehouse module can generate pick lists using FIFO or FTE (First to Expire) inventory controls. Requires: Receiving & Labeling Module. Enhanced By: Purchase Order Entry Module

Basic Scheduling Module

Using information from the Data Upload or Shop Order Entry Modules, this module provides basic scheduling functionality in a Gantt chart type environment. This module requires the manufacturing lines and shift information to be entered or uploaded into the ESF Suite. Daily production schedules can be printed using this module. Enhanced By: Shop Order Entry Module

Advanced Scheduling Module

Using information from the Data Upload or Shop Order Entry Modules, this module provides advanced scheduling functionality in a Gantt chart type environment. This module uses a drag and drop method to assign production orders to time slots for manufacturing equipment. Information from the Inventory, Warehousing and QA Control Modules can be used to check if a job can be run and will show the status of the job using color-coded flags. Daily production schedules can be printed using this module. With the Job Firming Module activated, the Advanced Schedule Module can be used to firm orders. With the QA Control Module activated, this module will also generate a QA hot list of material that needs to be re-sampled prior to production. Requires: Shop Order Entry, Inventory Modules. Enhanced By: QA Control, Warehousing, Job Firming Modules

Job Firming Module

This module is an engine that works in conjunction with Advanced Scheduling. It calculates each order's status based on its scheduled time slot and the associated available inventory. The business rules concerning inventory availability need to be uploaded or entered manually. Requires: Advanced Scheduling Module. Enhanced by: QA Control, Warehousing Modules.

Shop Floor Management Module

This module controls order availability on the production floor. Using information from either the Basic Scheduling or Advanced Scheduling Module, this module controls the generation of Pick Lists to the warehouse. This module can also control the flow of materials by allowing the generation of partial picks.

This module displays a layout of the facility and shows the lines that are currently scheduled and the production orders being run on them. Floor plans can be displayed entirely or in pieces. If production standards are entered or uploaded, the amount of labor to complete the order on the schedule will be displayed.

With the Production Floor Control module activated, current production floor data is displayed.

Enhanced By: Basic Scheduling or Advanced Scheduling, Production Floor Control, Warehousing Modules

The shop floor management module can read information from machines using PLCs or interpolate activity using printed header sheets. Can be used as a marketing tool, practical use increases with facility size.

Maintenance Module

The Maintenance Module is employed to initialize the system defining and entering various parameters of the facility. For example, the Maintenance Module will maintain a list of the various areas of the facility, maintain a list of the most general material categories, maintain a list of the specific material commodity groups, maintain a list of available process units used by this facility, maintain a list of all useable rack locations within the facility and set up shifts during which jobs can run.

Via the Maintenance Module, a user can define and maintain a list of storage distinctions (e.g. hazardous, refrigerated). These distinctions will be used as possible storage restrictions for materials and finished goods and as storage capabilities for rack locations.

Furthermore, the Maintenance Module will provide User Administration—the ability to create and maintain user accounts that can access ESF.

Third Parties Option Module

View the entire list of customers, suppliers, and vendors. Maintain a list of customers that hire this facility. Maintain a list of companies that supply this facility with materials. Maintain a list of companies that manufacture materials used by this facility.

Materials List Module

View the master list of materials. Search the master list of materials. Add a new material to the master list of materials. By employing the Material List Module, a user will create a database of materials used by the facility and associate parameters and/or to each material which will be used by various models to effect functionality based on the parameters and/or rules.

Production Floor Control Module

Using information from the Data Upload, Shop Order Entry, Inventory Control, either Schedule, and Shop Floor Management Modules, this module allows the control to be extended to the production floor.

The starting of the manufacturing order on the shop floor is entered here. If a unique lot or trace is required, it will be generated here. The line or equipment being used is entered here.

This module can use the RF Control Module to verify materials at the production line by scanning the material's barcodes—scanning materials is the best way to have total lot tracking of what materials went into the manufactured product. The RF Control Module allows RF emulation—this means that purchasing or RF guns or readers is not required.

As units are completed and boxed, this module will generate each box's label. The Shop Floor Control will display the materials scanned, consumed and produced throughout the production process.

Requires: Shop Order Entry, Shop Floor Management Modules

Enhanced By: Inventory Control, Either Scheduling, RF Control, Clean and Sanitization Control Modules

Shrinkage Control Module

This module uses the information of the materials picked or scanned to a specific Order, the amount consumed based on the BOM and the amount returned to the Warehouse to calculate the shrinkage (waste). The module allows manual adjustments to be made and explanations to be entered to account for the missing inventory. Reports are available based on the production order being run, the Finished Material and the individual items being consumed. If the cost of the items is part of the information imported or entered, that will be reflected in the report.

Enhanced By: Production Floor Control, Shop Order Entry Modules

Better than simple reconciliation—official job closeout

Production Labor Control Module

This module allows the entry and tracking of the labor used on a particular production Order. The labor information can be manually entered, or scanned into the module.

Enhanced By: Production Floor Control, Shop Order Entry, RF Control Modules

Specifically direct labor, indirect labor potentially. Job category, training skill tracking, health—examples of details tracked and used for history: “can be enhanced based on customer needs”

RF Control Module

RF scanners are not required to use this module because this module has an emulation mode that allows users to interact with the RF scanner's software on a computer. The implementation of RF scanners at a facility requires some additional hardware.

Some uses of the RF units are:
Inventory Control
Process Verification
Inventory Consumption
Lot Tracking
QA Status Check
Inventory Movement
Labor Tracking

Requires: Receiving & Labeling or Production Floor Control Module

Enhanced By: RF Scanner Hardware

RF cradle may be employed for non wireless readers. RF Emulation uses the same screens, therefore, no training is required if RF guns or reader are bought later.

Security signoff for self-wireless maintained networks.

Interplant Shipping Module

This module controls the shipping of materials between facilities of the same company. Both facilities must be ESF-Enabled Facilities controlled by the same ESF Owner account. Materials must meet the business rules before they are allowed to leave the facility. For example: materials that are not approved by QA cannot ship out. The module will create a packing list and a VICS BOL for the shipment.

Requires: RF Control Modules

Enhanced By: QA Control

Pre-Production Weighing and Kitting Module

Using information from the imported data or the Shop Order Entry, this module allows material to be picked, weighed out and labeled prior to production. This function may require the interface to scales or other equipment and needs to be reviewed on a case-by-case basis. This module usually requires the QA Control, Inventory Control and Warehouse Modules.

Requires: Receiving & Labeling Module

Enhanced By: QA Control, Inventory Control, Warehousing Modules

Kitting—Consolidation benefits: print reports, tracking, raw material usage, audit/order trails.

Pre-Production Staging Module

Using information from the Data Upload or Shop Order Entry Modules, this module allows material to be picked, counted and labeled prior to production. This function may require the interface to scales or other equipment and needs to be reviewed on a case-by-case basis. This module usually requires the QA Control, Inventory Control and Warehouse module. Helps bring out components, labels and caps. Different from Pre-weigh because: consolidate by multiple orders, more flexible.

Requires: Receiving & Labeling Module

Enhanced By: QA Control, Inventory Control, Warehousing Modules

Product Adjustments Module (in-Process & Post-Process)

Manufactured materials sometimes need adjustments after the actual process has completed, for example: reworks & shade adjustments. This module records those events and associates consumed inventory with that order. Any business rules imposed during the manufacturing process can also be enforced in this module. For example: additional labeling requirements or an additional process required for a fixed period after the manufacturing process completes.

Requires: Shop Order Entry Module

Enhanced By: QA Control, Receiving & Labeling, RF Control Modules

Cleaning and Sanitization Control Module (Pre-Production Preparation)

Many manufacturing processes require specific cleaning before and after manufacturing is complete—this module enforces and records the cleaning activities.

Site Located Stations

Some aspects of the ESF Suite require special hardware at the production facility in order to function properly, these include:
Custom Label Printing
Custom Interfaces
PLC Interfaces
Host System Interfaces
Data Gathering
Scale Interfaces
   Pre-Production Weighing
   Inventory Weight Adjustments
Videx—DuraTrax Data Collection (iButton) Module
   Employee Security
   Event Proof
   Temperature Recording

QA Control Module

Using information from the Data Upload or Receiving Modules, this module helps monitor and control materials based on QA decisions. The module supports the generation of Lot Numbers based on business rules, and the recording of expiration dates and basic sample results. This module also allows manufactured materials to be tracked all the way back to the received materials and the PO each was bought under. Additionally, samples from the Production Floor are controlled through this module.

Requires: Receiving & Labeling or Production Floor Control Module Enhanced By: RF Control, Production Floor Control Modules

Various modules of the system and method for monitoring and controlling a workflow control process, e.g., a shop floor, have been described. ESF Members can set up web reports specific to each of their customers—these reports can be accessed by their customers to check the status of and inventory levels associated with their order via a third party portal. Furthermore, ESF Members can utilize available system interfaces to write their own custom applications that interface with the ESF Suite. All or a portion of the various described modules may be utilized to effect the functionality of the system 100. An application of the system will now be describe below.

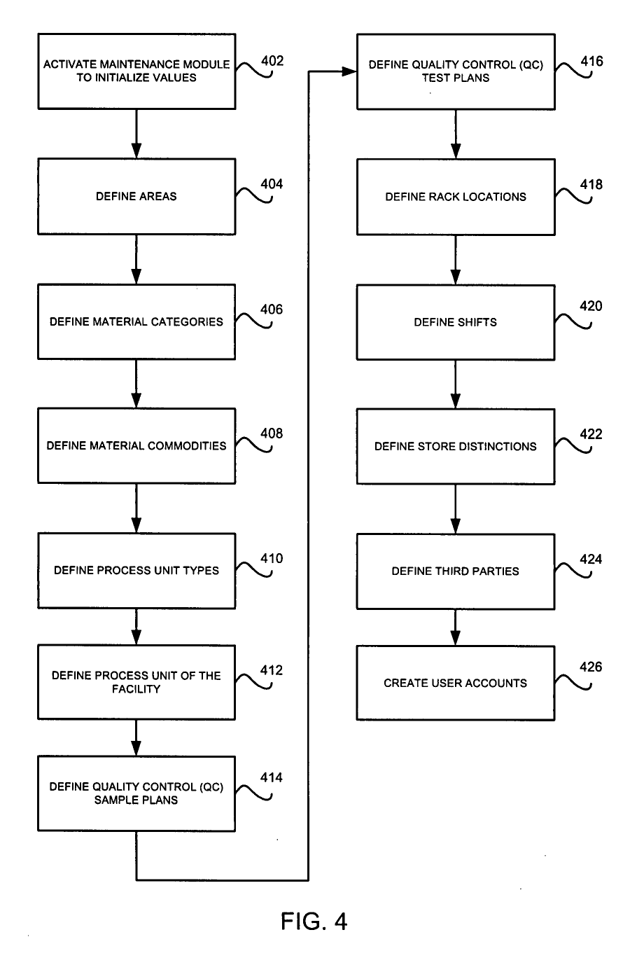

To utilize the system and method of the present disclosure, initial data elements will need to be defined and/or entered as illustrated in FIG. 4. To initialize these values, a user will activate the Maintenance Module for defining and entering values (step 402). Initially, in step 404, the user will define areas of the facility, e.g., dock, warehouse, offsite warehouse, production floor, etc. The user may also add storage capability to the area, that is, define if the area can be used for accommodating racks for material storage. Next, in step 406, material categories will be defined, e.g., component, finished goods, raw material, work in progress (WIP), etc. The user will assign a code to each category, e.g., at least a two letter code, and will define for the category initial quality control (QC) status, shelf life, QC sample plan and shrinkage. In step 408, a list of specific material commodity groups will be created. The user will assign a code to each material commodity, e.g., at least a three letter code, and will define for the material commodity initial quality control (QC) status, shelf life, QC sample plan and shrinkage.

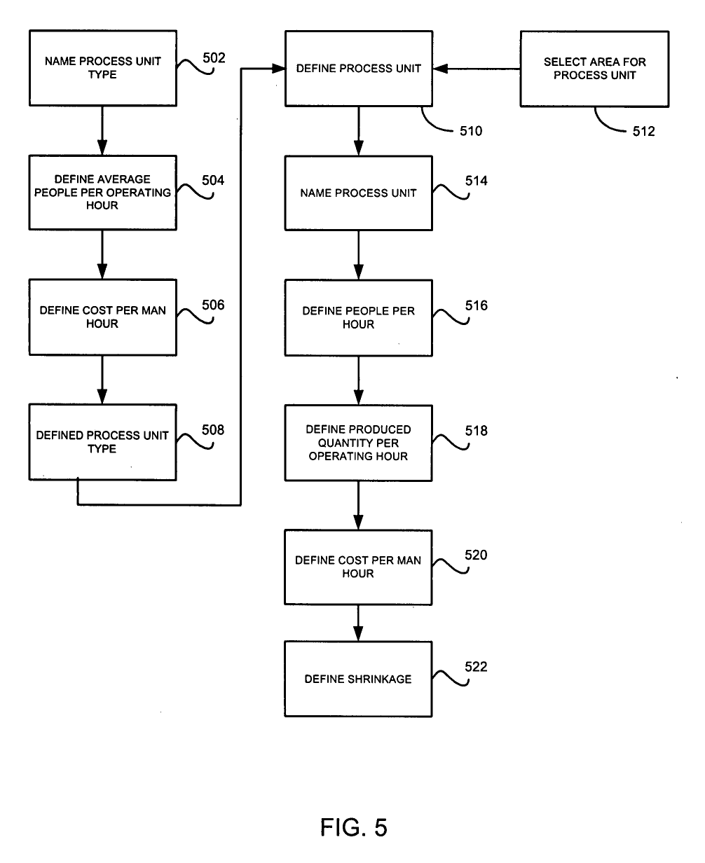

In step 410, process unit types are defined, e.g., scales, tablet press, etc. and, in step 412, process units for the facility are identified and associated with various variables as illustrated in FIG. 5. In step 502, a name is given to the process unit type. In step 504, an average number of people per operating hour needed to operate the process unit is defined and, in step 506, a cost per man hour is defined. A resulting defined process unit type 508 is then used to define the process units of the facility. In step 510, a new process unit is created and defined as a process unit type selected from the list of generated process unit types. In step 512, the area location of the process unit is selected from the areas of the facility defined in step 404 described above. Next, the process unit is given a name (step 514) and the following variables are associated to the process unit: people per operating hour (step 516), produced quantity per operating hour (step 518), cost per name hour (step 520) and shrinkage (step 522). Furthermore, support equipment may be associated to the process unit along with the required people per operating hour.

In step 414, sample quality control (QC) plans for the facility are generated and, in step 416, test QC plans for the facility are generated from the ample QC plans.

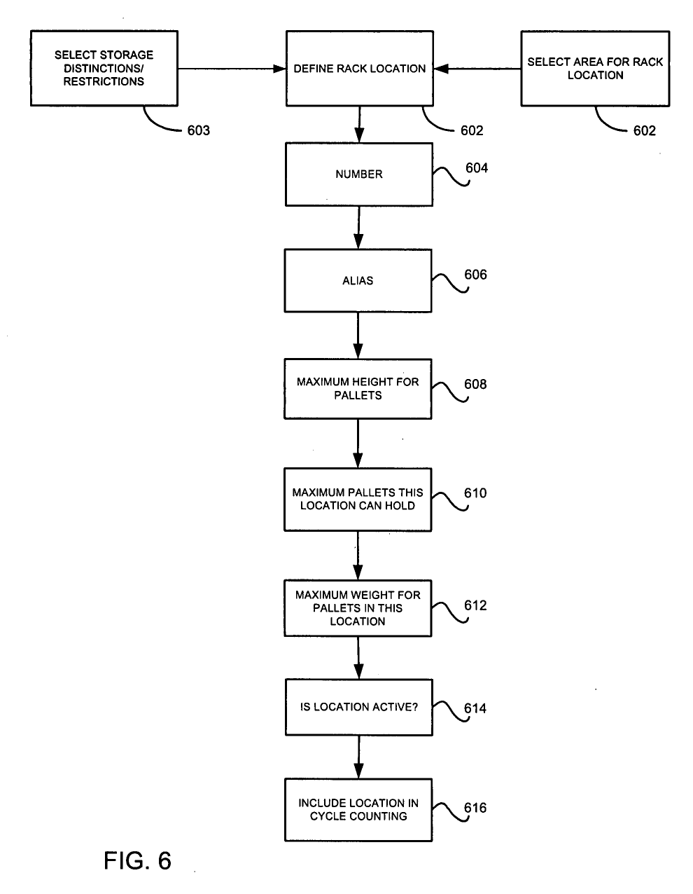

In step 418, a list of all usable rack locations within the facility is generated, as illustrated in FIG. 6. In step 601, a rack location is defined. The area for the rack location is selected in step 602 based on the areas defined in step 404 described above. Special storage capabilities, e.g., distinctions/restrictions, for the rack location are defined in step 603. Next, the rack location is given a number (step 604) and optionally, an alias in step 606. The following variables are associated to the rack location: maximum height for pallets (step 608), maximum pallets this location can hold (step 610), maximum weight for pallets in this location (step 612), whether the location is active (step 614) and if the rack location should be included in cycle counting (step 616).

Referring back to FIG. 4, in step 420, shifts are setup during which jobs or orders can be run. Generally, each shift will be defined with a start day and time and an end day and time. In step 422, a list of storage distinctions will be generated and maintained, e.g., refrigerated, hazardous, heat sensitive, humidity sensitive, light sensitive, etc. These storage distinctions will be used as possible storage restrictions for materials and finished goods and as storage capabilities for rack locations. In step 424, a list of third parties, e.g., customers, suppliers, vendors, manufacturers, etc., generally involved in the production order process is generated including contact information such as e-mail address which may be used for electronic ordering or the like. In step 426, user accounts are created and maintained which will determine the modules a newly defined user can access.

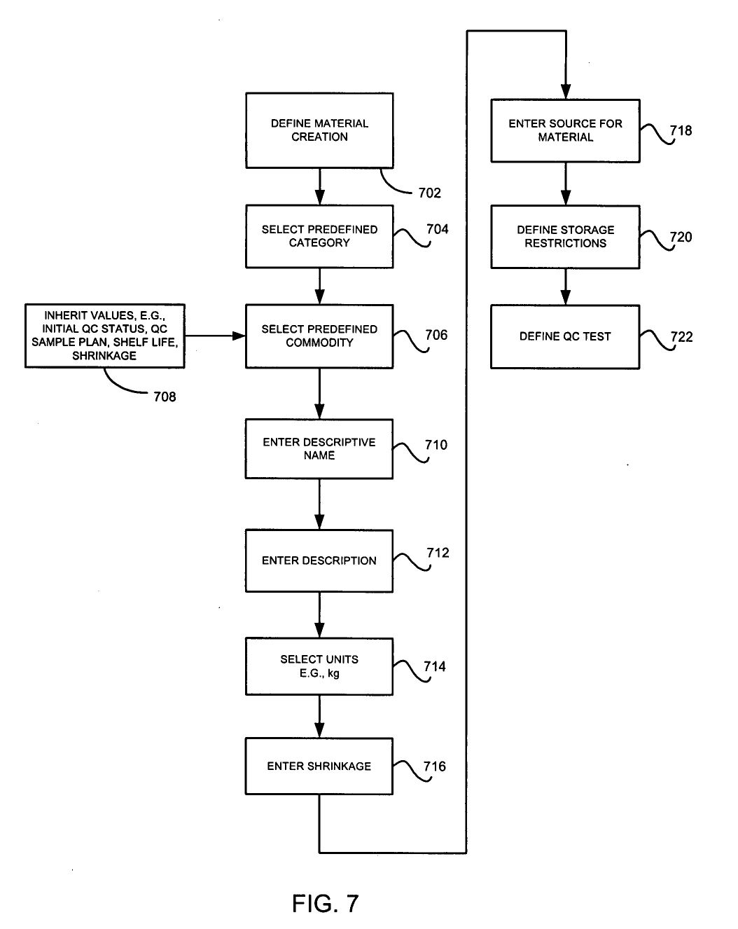

Once all the values are initialized via the Maintenance Module, a material list is created including any possible material utilized in a production order, as illustrated in FIG. 7, the Material List Module. In step 702, a material entry is created. A user will select a material categories (step 704) as defined in step 406 described above and will select a material commodity (step 706) as defined in step 408. Based on the selection of the material category and the material commodity, values are inherited to the new material, e.g., initial QC status, QC sample, shelf, shrinkage, etc. (step 708). In step 710, a descriptive name will be entered and a description (step 712). In step 714, a unit of measurement for the material will be selected and, optionally, in step 716, a shrinkage number will be applied.

In step 718, a source for the material, e.g., a third party supplier, may be added. When adding a source to the material, several variables may also be associated with the source for example an ordering unit of measure, purchase unit price, minimum order quantity, reorder quantity and delivery time. This information will be utilized in generating external supplier orders when material is needed for a production order. In step 720, a storage restriction may be associated to the material as defined in step 422 above. Furthermore, QC test may be associated to the material as described in step 416 above.

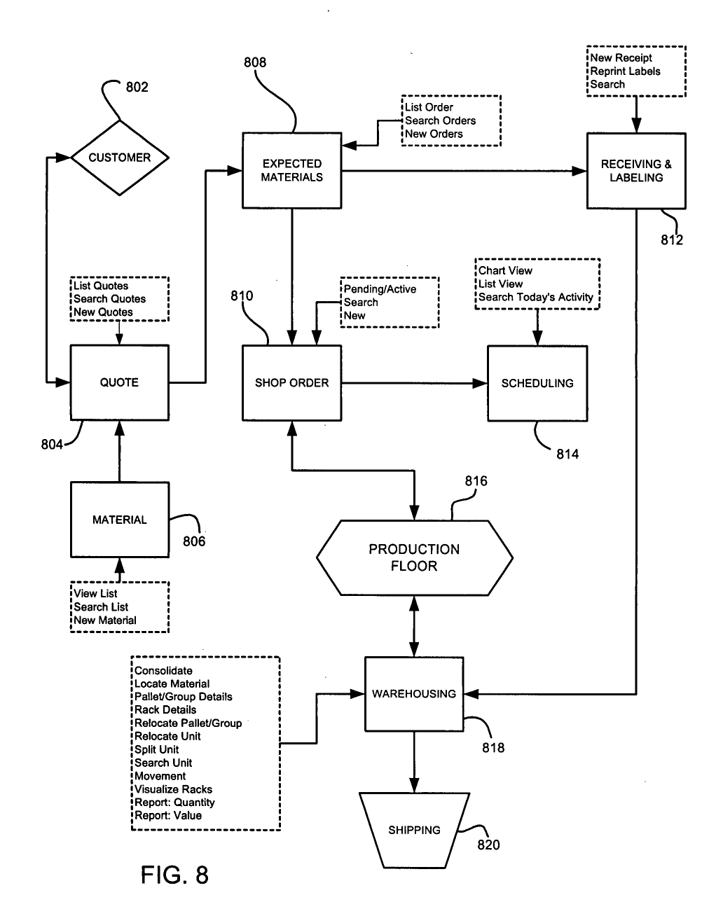

Referring to FIG. 8, an overall flowchart illustrating the operation of the system and method of the present disclosure is provided. The dashed boxed in FIG. 8 indicate possible actions a user may performed at each step.

The process initially begins with a customer 802 requesting a quantity of a product to be produced, e.g., a pharmaceutical company requesting a production run of a certain tablet or pill. In one embodiment, the customer may contact the production entity, e.g., the manufacturing company, and request a quote via telephone, facsimile or by any other known means wherein the production entity will enter the quote via a client 108, 110, 112. In another embodiment, the customer may electronically access the quoting module at the production facility via a third party portal employing any one of the protocols described above.

Via the Quoting Module 804, the particulars of an order will be entered or associated with the order via a client. In general, at least three elements will be entered or associated with the order: (1) process units, e.g., a scale, a tablet press or any other machinery involved in the production of the order; (2) activities, e.g., visual inspection of machinery, visual inspection of the product; and (3) material needed, e.g., ingredients, composition, etc. It is to be appreciated that the elements may be predefined and stored in a database, as described above, so the elements may be selected from a drop-down list or other known method. For example, a material list 806, as described in relation to FIG. 7, will allow a user to select the needed materials from a list, perform a search of the materials in the list or add new materials to the list. Furthermore, a quote and corresponding elements may be selected from a similar quote that was previously predefined or previously fulfilled, i.e., clone a quote. In this scenario, the elements for the quote are selected and a user may only have to adjust the quantity for this particular production run.

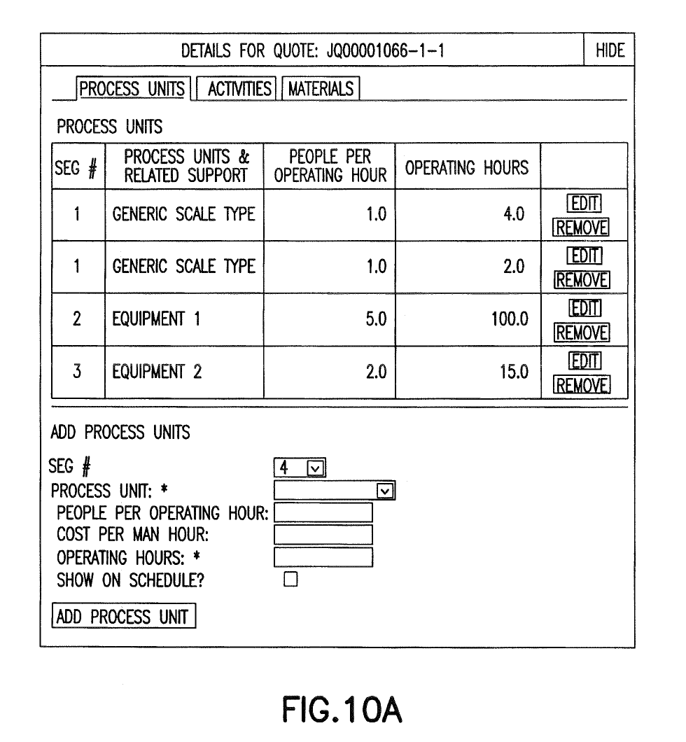

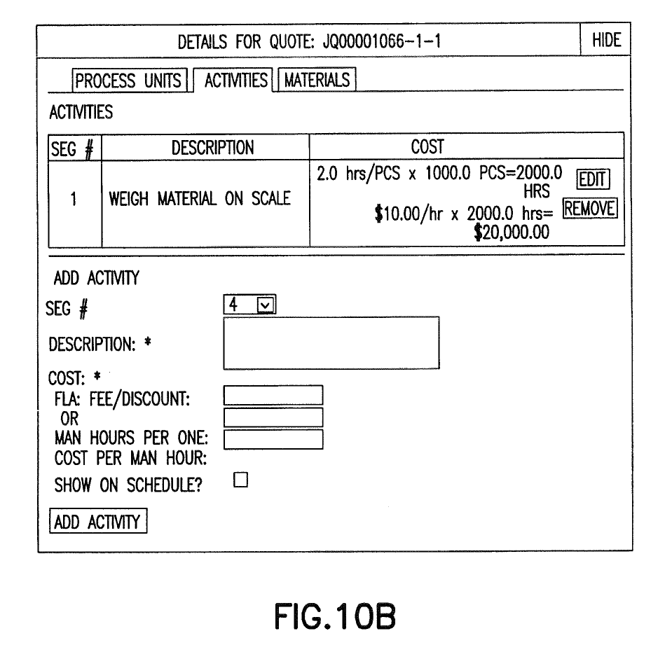

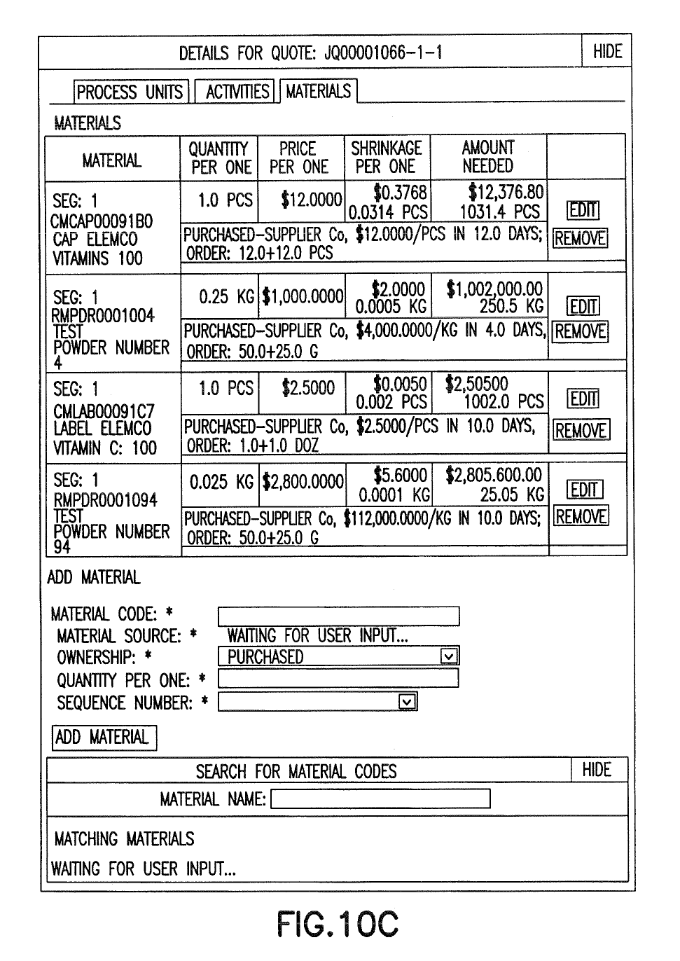

A process unit is any piece of equipment needed to complete the production order, for example, scale, tablet press, etc. Each process unit will have associated with it a number of people per operating hour required to operate the process unit; the cost per man hour to operate the process unit and the hours of operation of the process unit, as described above in relation to FIG. 5. An exemplary screen shot illustrating process units being added to a quote is shown in FIG. 10A. The associated parameters will determine cost for a quote when a predetermined process unit is selected and determine the labor required in conjunction with the scheduling module for the particular production order. Furthermore, for each process unit selected for the order, the user will assign a sequence number to the process unit to define when it is to be used in the manufacturing of the production order.

Similarly, each activity will have associated with it at least one of a flat fee for activity, man hours per activity and cost per man hour. A sequence number will also be assigned to each activity for determining the ordering of activity of the order in conjunction with the sequence numbers assigned to the process units. An exemplary screen shot illustrating activities being added to a quote is shown in FIG. 10B. Furthermore, the material required for the production order will have associated with each type of material at least one of a quantity per one (e.g., weight, number of pieces, etc.) price per unit and shrinkage per one. The material will then be assigned to one of more sequence numbers defined above. An exemplary screen shot illustrating material being added to a quote is shown in FIG. 10C. The above three elements will determine the cost and labor for each entered or selected quote and determine the sequence of utilizing process units and performing activities. Before finalizing the quote, the user may markup any or all of the process unit cost, activity cost and material cost by a predetermined amount or percentage to determine a final cost for the production order.

Once the quote for the production run is finalized, the process will proceed to the Expected Materials Module 808. The Expected Material Module 808 will determine the materials on-hand to perform the production run of the quoted order. If all of the material needed for the production run is not available based on warehouse inventory, the Expected Material Module 808 will generate external supplier orders to acquire the remaining material needed. In one embodiment, the Expected Material Module 808 will generate a paper order that can be mailed or faxed to an external supplier. In another embodiment, the expected material module 808 will electronically contact the external supplier to order the necessary material for example via e-mail, a direct connection, etc.

If the necessary materials are on-hand, the process will proceed to the Shop Order Module 810. Otherwise, the process will proceed to the Receiving and Labeling Module 812. The Receiving and Labeling Module 812 records the arrival of materials from external suppliers and generates required labels to associate the material to a quote and to indicate a location the material is to be placed at, e.g., on the production floor 816, in the warehouse 818, etc. It is to be appreciated that material entering the facility may be for inventory, i.e., order-less material, and not for a specific production order. In this scenario, the Receiving and Labeling Module 812 will generate labels indicating a location for the received material to be stored, e.g., a rack location. Furthermore, the Receiving and Labeling Module 812 will consolidate pallet(s) of the received material with material that is on-hand in the facility if necessary and generate a consolidation pallet label for the entire pallet. It is to be appreciated that the Receiving and Labeling Module 812 may be accessed via an available client located or positioned to the area where material is received, e.g., a loading dock.

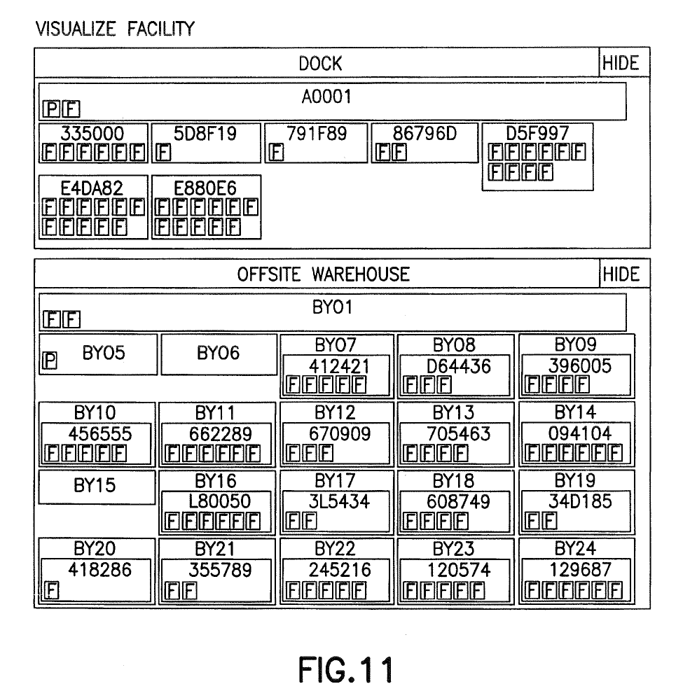

The information entered or generated by the Receiving and Labeling Module 812 will be transmitted to and/or shared with the Warehousing Module 818. The Warehousing Module 818 acts as a locator system and allows materials to be located manually or using RF guns or readers 116. The Warehousing Module 818 enables a user to locate material by a code associated to the material, an area of the facility, the status of the material, a quality control (QC) status of the material. An exemplary screen shot employed to locate material and visualize the facility generated via the Warehousing Module is illustrated In FIG. 11. The Warehousing Module returns materials to the warehouse, generates cycle count reports and bar coded labels and generates pick lists using FIFO or FTE inventory controls.

Once all the necessary material is on-hand, the production run can begin. The Shop Order Module 810 controls the manufacturing order on the production floor 816. At this point in the process, process units, activities and materials may be added to the production order if necessary. Also, any storage restrictions for finished goods may be associated to the production order at this time. Once changes have been made or the initial order has been verified, the order is ready for production.

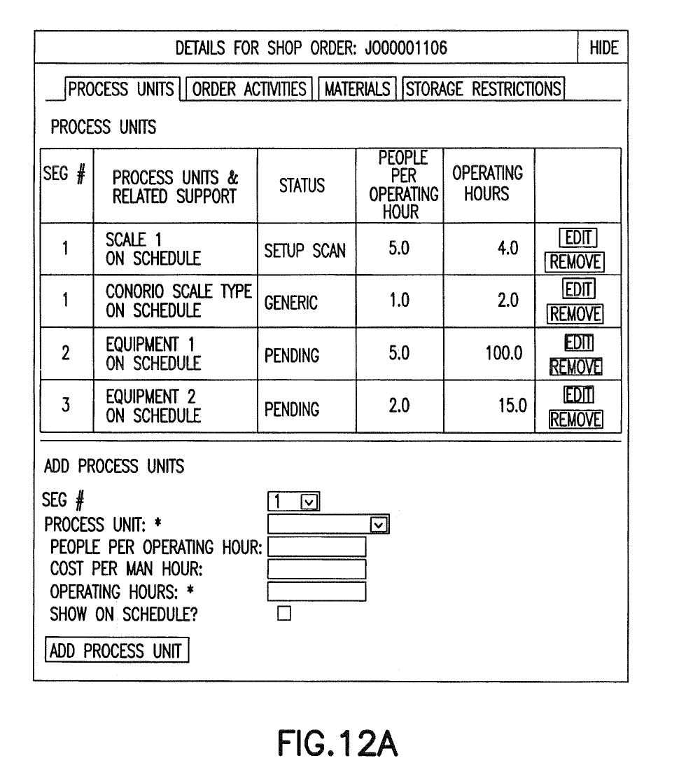

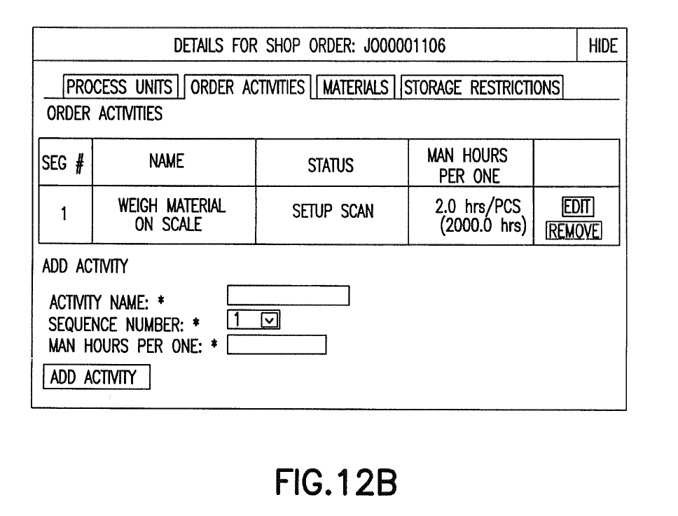

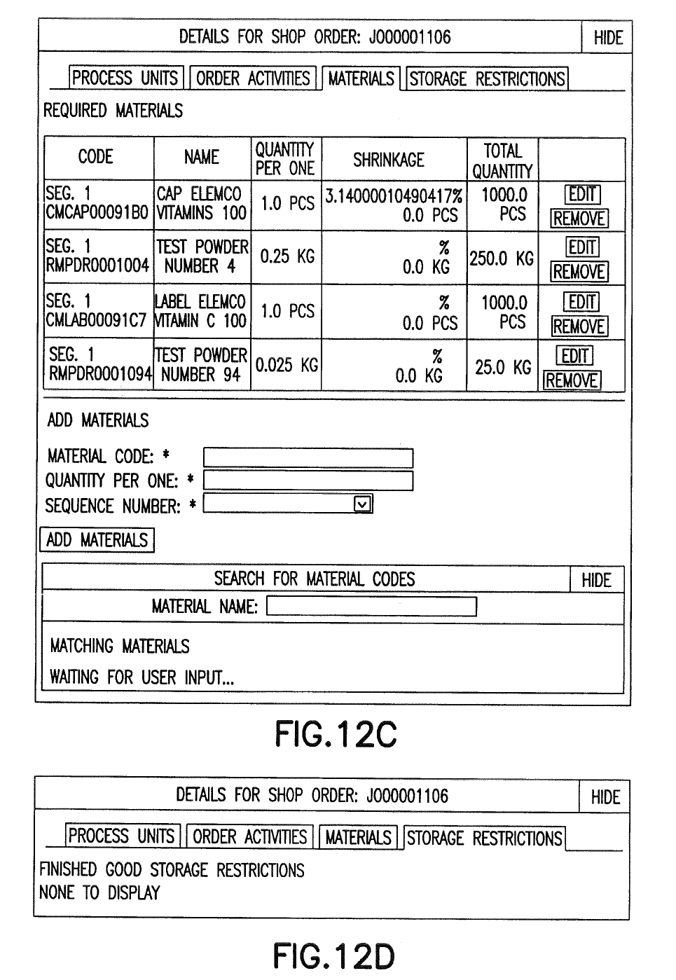

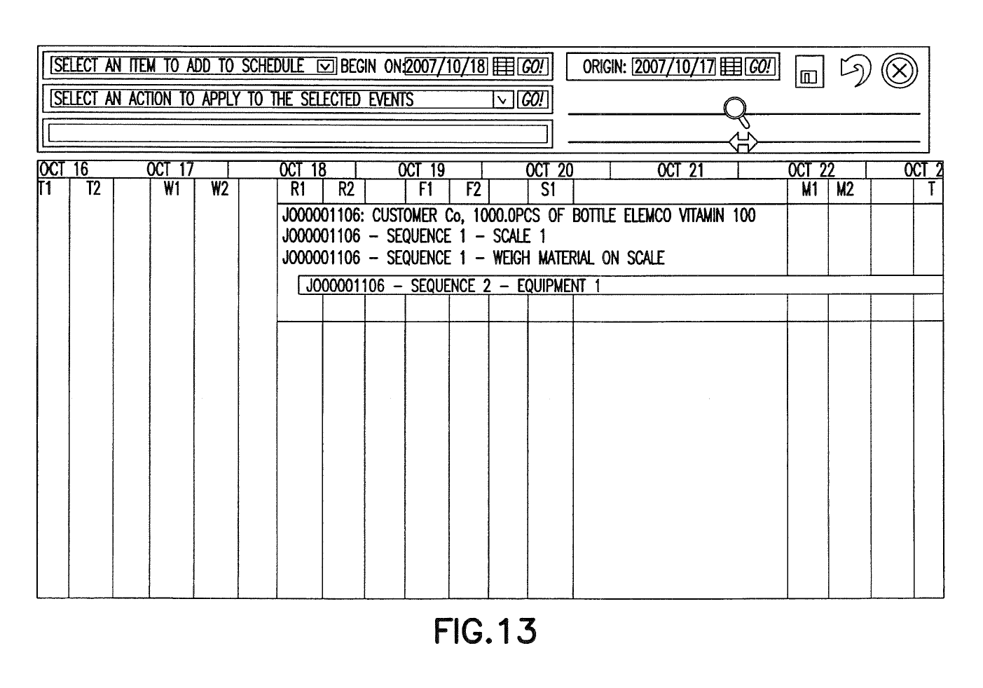

Initially, a setup scan is performed to verify the materials at the production line. Setup scan requires the user to scan all the materials to each process unit for each sequence of the shop order, e.g., via the RF control module. Once the material has been verified, the Shop Order Module 810 interacts with the Scheduling Module 814 to schedule use of associated processing units, e.g., a scale, and the necessary labor. Once the scheduling has been confirmed, the production order will be commenced for example an indication will be provided that all material and labor necessary for the order are in place and the production run can begin. As units are completed and boxed, the Shop Order Module 810 will generate each box's label. The Shop Order Module 810 will display the materials scanned, consumed and produced throughout the production process. FIGS. 12A-C are exemplary screen shots of a shop order being processed by the system and method of the present disclosure where FIG. 12A shows details of process units being utilized, FIG. 12B shows status of activities and FIG. 12C shows details of materials for the shop order. Furthermore, the scheduling of the shop order on the production floor according to the assigned sequence numbers can be visualized as shown in FIG. 13.

Once the production order is complete, the boxed finished product is warehoused 818. The labels generated for the finished products will include if there are any storage restrictions, e.g., if the finished product needs to be refrigerated. An exemplary screen shot showing any storage restrictions associated to the shop order is shown in FIG. 12D. The finished product will then be moved to shipping 820 based on its shipping schedule.

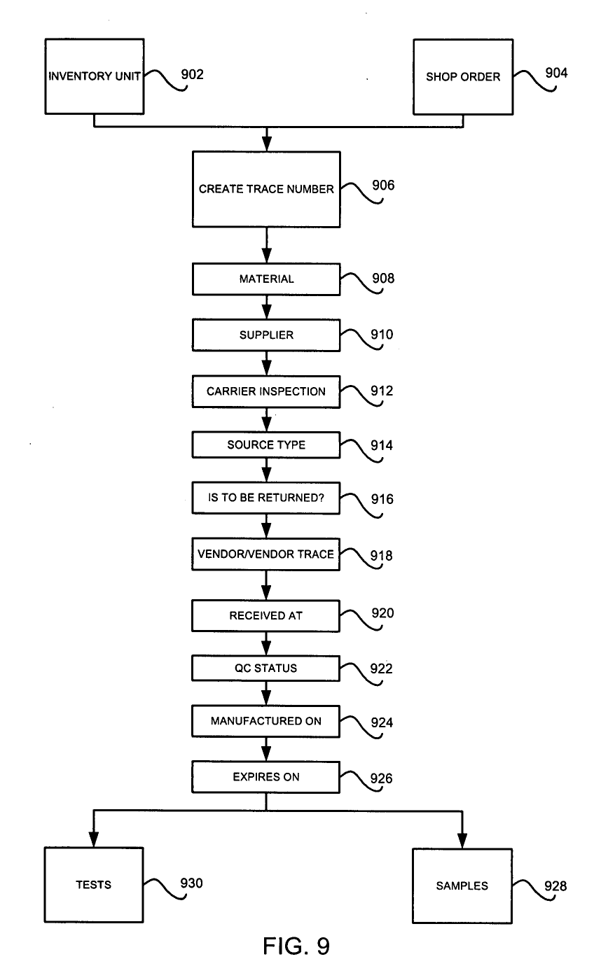

The Quality Control Module allows manufactured materials to be tracked all the way back to the received materials and the external supplier order, e.g., a purchase order (PO), each was bought under. Additionally, samples from the production floor are controlled through this module. Referring to FIG. 9, after items of material are received into inventory (step 902), a trace number is generated for the material in step 906. The following information is then associated with the trace number: the material code (step 908), the supplier of the material (step 910), carrier inspection information (step 912), a source type (step 914), whether the material is to be returned (in step 916), vendor name and vendor trace number (step 918), received at information (step 920), QC status (step 922), manufactured on date (step 924), and expires on date (step 926). For each QC trace number, a predetermined number of samples will be identified, in step 928, and samples will be tested, in step 930. The QC trace will basically follow the material throughout the production order. Similarly, a QC trace is generated for a shop order at step 904. The shop order trace will have similar information associated to it as the material trace following steps 906 through 926. The shop order trace of the finished product will include information on the material traces of the individual materials used to create the finished product. In this manner, all materials entering the facility can be tracked from receipt at the loading dock until it is shipped as a finished product.

It is to be appreciated that a portion or less than all of the modules described above may be implemented or configured in various ways to achieve standalone systems that do not required all the modules. For example, the modules may be configured in an inventory locator system implementation. In this scenario, a manufacturer wants to be able to reliably locate inventory within their warehouse. In this case, inventory includes both the inventory that the manufacturer owns from purchase orders generated by their financial package and inventory located within the facility that is owned by a customer. Furthermore, the facility lacks an inventory system, the warehouse's racks are not labeled nor logically ordered, and some of the current inventory is not properly labeled. The Receiving and Labeling and Warehousing Modules can be implemented in parallel to achieve the inventory locator system. The Receiving and Labeling Module will generate labels for pallets and containers so they can be recognized by the Warehousing Module. Additionally, the Receiving and Labeling Module will keep a record of inventory received from both P.O.'s, i.e., purchase orders, and from customers; quantity and item code will be validated on inventory received from a PO. The Warehousing Module will help label rack locations and will then be able to allow users to manually locate, pick and return inventory.

Due to the server/client architecture of the system and method of the present disclosure, any client application, e.g., an Internet browser, having access to the network the server is residing on, e.g., the Internet, may have access to the server and the functionality provided thereon. Furthermore, the server hosting the shop floor module or ESF Suite 210 will include a third party portal which will give limited access to third parties such as customers, suppliers, vendors, etc. of the facility. Via the third party portal, third party users will be provided with the following functionality: view quotes, view receipts, view shop order, view users, view materials, and create and view purchase orders.

While the disclosure has been shown and described with reference to certain preferred embodiments thereof, it will be understood by those skilled in the art that various changes in form and detail may be made therein without departing from the spirit and scope of the disclosure.

What is claimed is:

1. A system for managing a production order of a shop floor comprising:
a quoting module configured for selecting at least one process unit, at least one activity and at least one material for the production order;
a shop order module configured for verifying the selected at least one material is available for production;
a scheduling module configured for scheduling use of the selected at least one processing unit and determining an amount of labor needed based on the selected at least one process unit and at least one activity;
wherein the shop order module is further configured to verify the availability of the amount of labor and provide an indication to commence production upon verification of the availability of the selected at least one material and the needed labor.

2. The system of claim 1, wherein the quoting module is further configured to associate with the at least one process unit one of a number of people per operating hour required to operate, a cost per man hour to operate and hours of operation.

3. The system of claim 1, wherein the quoting module is further configured to associate with the at least one activity one of a flat fee for activity, man hours per activity and cost per man hour.

4. The system of claim 1, wherein the quoting module is further configured to associate with the at least one material one of a quantity per one of the material, price per unit and shrinkage per one.

5. The system of claim 1, further comprising an expected materials module configured to determine if the selected at least one material is in inventory.

6. The system of claim 5, wherein the expected materials module is further configured to generate an external supplier order if the selected at least one material is not inventory.

7. The system of claim 6, further comprising a receiving and labeling module configured to record the receipt of materials from an external supplier and generate a label to associate the received material to the production order.

8. The system of claim 7, wherein the receiving and labeling module is further configured to indicate a location for the received material.

9. The system of claim 1, wherein the quoting module is further configured for assigning a sequence number to the at least one process unit and at least one activity, wherein the at least one process unit and the at least one activity is processed sequentially according to the assigned sequence number.

10. The system of claim 9, wherein the quoting module is further configured to assign the selected at least one material to the selected at least one process unit and/or at least one activity.

11. The system of claim 1, further comprising an RF module configured for entering material into inventory, wherein the shop order module verifies the selected at least one material based on an amount of the selected at least one material in inventory.

12. The system of claim 1, wherein the quoting module is configured for determining a cost for the production order.

13. A method for managing a production order of a shop floor, the method comprising the steps:
providing a web site for generating a production order hosted by at least one server in communication with the network;
receiving an indication for selecting at least one process unit, at least one activity and at least one material for the production order by the web site;
verifying the selected at least one material is available for production;
scheduling use of the selected at least one processing unit and determining an amount of labor needed based on the selected at least one process unit and at least one activity by the web site;
verifying the availability of the amount of labor; and
providing an indication to commence production upon verification of the availability of the selected at least one material and the needed labor.

14. An apparatus for managing a production order of a shop floor over a network comprising:
means for providing a web site for generating a production order hosted by at least one server in communication with the network;
means for receiving an indication for selecting at least one process unit, at least one activity and at least one material for the production order by the web site;
means for verifying the selected at least one material is available for production;
means for scheduling use of the selected at least one processing unit and determining an amount of labor needed based on the selected at least one process unit and at least one activity by the web site;
means for verifying the availability of the amount of labor; and
means for providing an indication to commence production upon verification of the availability of the selected at least one material and the needed labor.

15. A system for managing a production order of a shop floor over a network comprising:
at least one first server in communication with the network configured for generating a production order; and
at least one first client in communication with the network configured for selecting at least one process unit, at least one activity and at least one material for the production order;
wherein the at least one first server further configured for verifying the selected at least one material is available for production, scheduling use of the selected at least one processing unit and determining an amount of labor needed based on the selected at least one process unit and at least one activity, verifying the availability of the amount of labor and providing an indication to the at least one first client to commence production upon verification of the availability of the selected at least one material and the needed labor.

16. The system of claim 15, wherein the at least one first client is further configured to associate with the at least one process unit one of a number of people per operating hour required to operate, a cost per man hour to operate and hours of operation.

17. The system of claim 16, wherein the at least one first client is further configured to associate with the at least one activity one of a flat fee for activity, man hours per activity and cost per man hour.

18. The system of claim 15, wherein the at least one first client is further configured to associate with the at least one material one of a quantity per one of the material, price per unit and shrinkage per one.

19. The system of claim 15, wherein the at least one first server is configured to determine if the selected at least one material is in inventory.

20. The system of claim 19, wherein the at least one first server is further configured to generate an external supplier order if the selected at least one material is not inventory and transmit the generated external supplier order to at least one second server.

21. The system of claim 20, wherein the at least one first server is configured to record the receipt of materials from the external supplier and generate a label at the least one client to associate the received material to the production order.

22. The system of claim of 21, wherein the at least one first client is further configured for assigning a sequence number to the at least one process unit and at least one activity, wherein the at least one process unit and the at least one activity is processed sequentially according to the assigned sequence number.

23. The system of claim 22, wherein the at least one client is further configured to assign the selected at least one material to the selected at least one process unit and/or at least one activity.

24. The system of claim 15, wherein the at least one first client is configured for entering material into inventory, wherein the at least one first server verifies the selected at least one material based on an amount of the selected at least one material in inventory.

25. The system of claim 15, wherein the at least one first server is configured for determining a cost for the production order.
